(19) United States
(12) Patent Application Publication
(10) Pub. No.: US 2018/0188013 A1
(43) Pub. Date: Jul. 5, 2018

(54) BRAKE LINING MEASUREMENT SPECIALTY TOOL KIT

(71) Applicant: Rafael Garcia, Fontana, CA (US)

(72) Inventor: Rafael Garcia, Fontana, CA (US)

(21) Appl. No.: 15/398,673

(22) Filed: Jan. 4, 2017

(51) Int. Cl. G01B 5/06; B23K 26/36; F16D 65/00

(52) U.S. Cl. CPC G01B 5/061; F16D 65/0043; B23K 26/36

(57) ABSTRACT

A Specialty Tool Kit for measuring the thickness of: Automotive Rotary Disc Brake Pads; the brake lining of conventional automobiles/Light Trucks utilizing Wheel Drum Brakes Shoes; Heavy-Duty Air Brake Systems utilizing Wheel Drum Brake Shoes; and exposed train rail Disc Brake pads is disclosed. The tool kit comprises a shaft comprising a first end and a second end to define a predetermined length of rectangular cross-section, wherein the first end is a handle configured to have a gripping section and the second end is a gauge section configured to measure the thickness of the brake lining via a recessed area of predefined height minimizing the removal of the respective wheel assembly of the automobile. The tool kit comprises different shafts with gauge sections of predefined dimensions to measure the thickness of the brake lining material thickness of various automotive Brake System configurations and exposed train rail car Disc Brake pads.

### BACKGROUND

Disc Brake pads and Brake Shoe lining are the frictional elements, which have a significant role in the braking system. Vehicles employing a Disc Brake System, utilize Disc Brake pads on the front axle and in many cases the rear axle to provide better braking performance superior to Wheel Drum Brake Shoes. Generally, Disc Brake pads are made from a composite material with some friction media layered to resist the motion of the rotor. However, over time, these Disc Brake pads wear due to repeated usage and therefore it is necessary to measure the material thickness of the Disc Brake pad lining to keep the braking performance efficient. To do so, the mechanic must typically remove the wheel completely to perform the process of measuring the material thickness of the Disc Brake pad, requiring both a significant amount of manual labor as well as time.

Previous attempts have been made to provide various tools to measure the thickness accurately after removing the wheel. Most tools used to determine Disc Brake lining material thickness and or Wheel Drum Brake Shoe lining wear are based upon the ruler structure of the tool. The Disc Brake assembly in conjunction with the wheel assembly configuration is inherently obstructive varying from vehicle to vehicle and therefore a single tool cannot not help in analyzing the brake lining material thickness effectively on all varying configurations if the tool is designed to measure with the wheel on the axle. Each Disc Brake assembly design has its own unique inherent physical obstructions that may delay work time to measure the thickness accurately. Length and design of the measuring tools must also fit the configuration of the wheel assembly.

Prior art reference U.S. Pat. No. 5,970,427 discloses a brake testing device for testing the condition of the disk of a wheel mounting assembly, wherein a pair of gauges with sensors are used to generate a plurality of signals corresponding to the measured position. However, the design of the device is cumbersome and may not be used on various automobile wheel configurations.

Due to the aforementioned drawbacks and limitations, there exists a need for a tool kit to precisely measure the thickness of a Disc Brake pad installed in a Rotary Disc Brake system of automobiles/light trucks in addition to Wheel Drum Brake Shoes in conventional automobiles/light trucks in varying degrees of difficulty without removing the wheel wherever possible.

### SUMMARY

The objective of the present invention is to provide a specialty tool kit to accurately measure the Disc Brake pad material thickness of an automobile/light truck utilizing a rotary Disc Brake system without removing the wheel assembly in most cases.

According to one embodiment of the present invention, the brake lining measurement specialty tool kit comprises a shaft comprising a first end and a second end to define a predetermined length of rectangular cross-section, wherein the first end is a handle configured to have a gripping section and the second end is a gauge section configured to measure the material thickness of a Disc Brake pad or Wheel Drum Brake Shoe lining material thickness via a gauge's recessed area of predefined height without removing a wheel off of the automobile.

According to a preferred embodiment of the present invention, the brake lining measurement specialty tool kit is comprised of at least five shafts with gauge sections of predefined dimensions to measure the thickness of the brake lining of various automotive brake systems.

### BRIEF DESCRIPTIONS OF SEVERAL VIEWS OF DRAWINGS

FIG. 1 Illustrates a Standard Disc Brake Gauge for measuring the material thickness of a Disc Brake pad of a rotary disc Rotary Disc Brake system of an automobile/light truck, incorporating the aspects of the present invention.

FIG. 2 Illustrates a Heavy-Duty Brake Feeler Gauge being utilized to be inserted through the inspection access window of a wheel drum brake cover from the inboard side of the wheel of an automobile/light truck, incorporating one of the aspects of the present invention

FIG. 3 Illustrates a general descriptive Disc Brake pad design for an automobile/light truck, with the size and design being proportional to the respective size and weight of vehicle, incorporating the aspects of the present invention.

FIGS. 4A, 4B and 4C Illustrates a Heavy-Duty Brake Feeler Gauge in measuring the material thickness of the Disc Brake pad of an automobile/light truck Disc Brake, incorporating the aspects of the present invention.

FIGS. 5A and 5B Illustrates a method of using the Heavy-Duty Brake Feeler Gauge in measuring the material thickness of a Disc Brake pad of an automobile/light truck, incorporating the aspects of the present invention.

FIGS. 6A, 6B and 6C illustrates an Inspection/Access Window Disc Brake Gauge utilized in measuring the material thickness of the Disc Brake pad of the rotary Disc Brake system of an automobile/light truck, incorporating the aspects of the present invention in addition to being utilized for measuring the Wheel Drum Brake Shoes on Heavy-Duty Air Brake Systems.

FIGS. 7A, 7B and 7C Illustrates the method of using the Inspection/Access Window Disc Brake Gauge in measuring the material thickness of the Disc Brake pad of the Rotary Disc Brake system of an automobile/light truck, incorporating the aspects of the present invention.

FIGS. 8A, 8B and 8C Illustrates the Standard Disc Brake Gauge for measuring the material thickness of the Disc Brake pad of a rotary Disc Brake system of an automobile/light truck, incorporating the aspects of the present invention.

FIGS. 9A and 9B Illustrates the method of using the Standard Disc Brake Gauge in measuring the material thickness of the Disc Brake pad of the rotary Disc Brake system of an automobile/light truck, incorporating the aspects of the present invention.

FIGS. 10A and 10B Illustrate an Extended Disc Brake Gauge for measuring the material thickness of a Disc Brake pad of a rotary Disc Brake system of an automobile/light truck, incorporating the aspects of the present invention.

FIGS. 11A and 11B Illustrates the method of using the Extended Disc Brake Gauge for measuring the material thickness of the Disc Brake pad of the rotary Disc Brake system of an automobile/light truck, incorporating the aspects of the present invention.

FIGS. 12A and 12B Illustrate an Ambidextrous “S” Hammer Head Disc Brake Gauge for measuring the material thickness of the Disc Brake pad of the rotary Disc Brake system of an automobile/light truck in cases where physical constraints between the wheel and rotary Disc Brake assembly require an inverted position of the measuring dimension of the gauge, incorporating the aspects of the present invention.

FIGS. 13A and 13B Illustrates the method of using the Ambidextrous “S” Hammer Head Disc Brake Gauge in measuring the material thickness of the. Disc Brake pad of the rotary Disc Brake system of an automobile/light truck in cases where physical constraints between the wheel and rotary Disc Brake assembly require an inverted position of the measuring dimension of the gauge, incorporating the aspects of the present invention.

### DETAILED DESCRIPTION OF DIFFERENT EMBODIMENTS

The present invention, the brake lining measurement specialty tool is designed to provide a brake lining measurement Specialty Tool Kit 100 to measure a Disc Brake pad material thickness of an automobile/light truck Disc Brake assembly, automobile/light truck Wheel Drum Brake Shoe material thickness wherein an inspection window is incorporated into the rear of the Brake Drum cover; Heavy-Duty Air Brake System Wheel Drum Brake Shoe lining; and train railway Disc Brake pad lining.

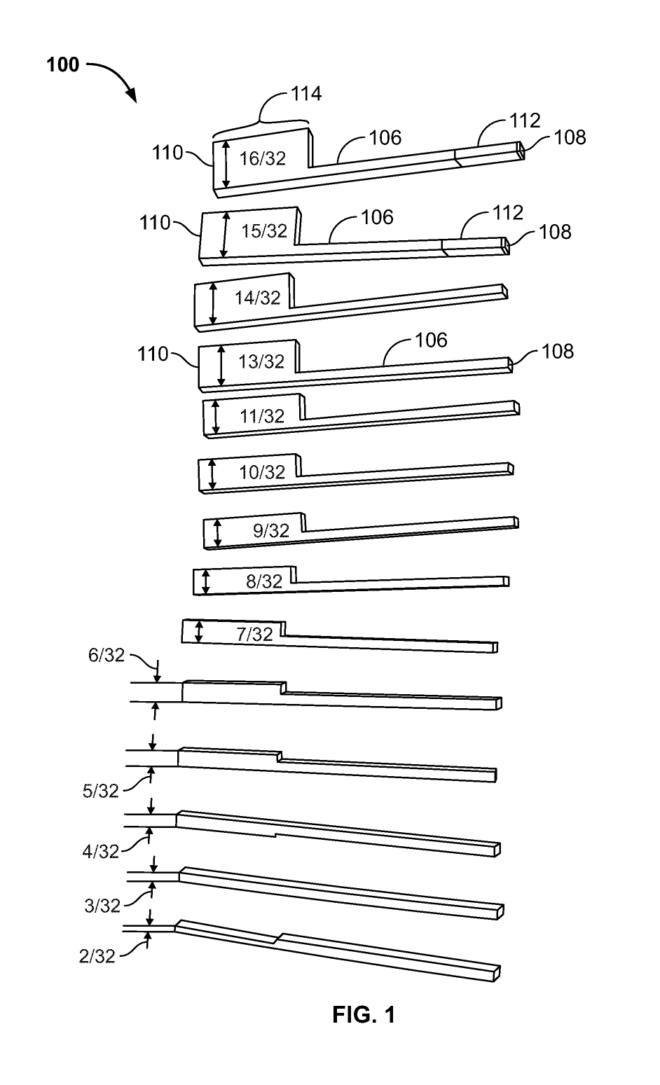

The embodiments shown in FIG. 1, of the brake lining measurement Specialty Tool Kit 100 illustrate the essential component sections of a tool gauge for measuring the material thickness of a Disc Brake pad of an automobile/light truck rotary Disc Brake assembly in increments of 1/32 an inch of as shown in FIG. 1. The Specialty Tool Kit 100 comprises a shaft 106 comprising a first end 108 and a second end 110 to define a predetermined length of rectangular cross-section, wherein the first end 108 is a handle configured to have a gripping section 112 and the second end 110 is a gauge section 114 configured to measure Disc Brake pad material thickness 104 via a recessed area of predefined height between the Disc Brake pad backing plate and the Disc Brake rotor in which space the Disc Brake pad material exists, in which case the brake lining is measured as noted in 9A and 9B without the necessity of removing a wheel off of the automobile/light truck axle being inspected. The handle of the first end 108 allows a user to conveniently hold the shaft 106 with the help of the gripping section 112 and to properly navigate the tool gauge 100 into the Disc Brake assembly for measurement.

As shown in FIG. 1, the Specialty Tool Kit 100 comprises at least fourteen shafts 106 with gauge sections 114 and 110 of predefined dimensions and shapes to gauge the thickness of the Disc Brake pad 104 of various automobile wheel configurations, Wheel Drum Brake Shoe lining, Heavy-Duty Truck Air Brake Wheel Drum Shoe lining of automotive vehicles and train railway Disc Brakes. Section 114 and 110 of the tool kit 100 are configured to measure brake lining material thickness ranging from 3/32 inches to ½ inch. The different configurations of the gauge sections 110 and 114 of the shaft 106 gauge the brake lining material thickness in specified ranges, in increments of 1/32 of an inch in specific embodiments of the Specialty Tool Kit 100. The shaft 106 of the Specialty Tool Kit 100 is made from a malleable metal alloy material for improved flexibility and durability.

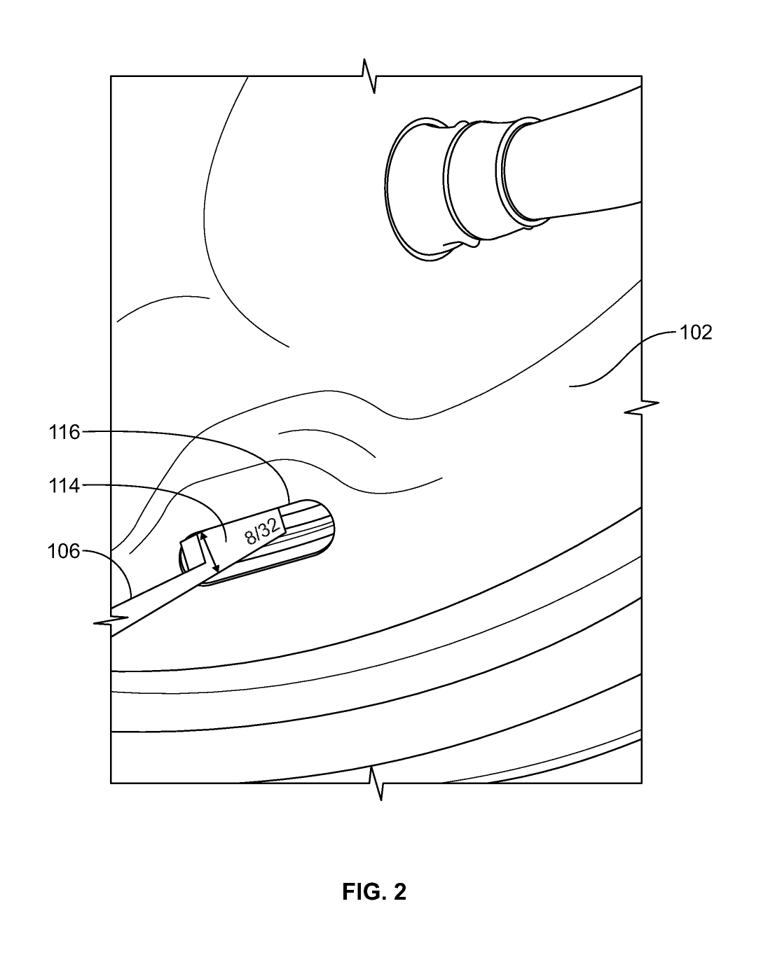

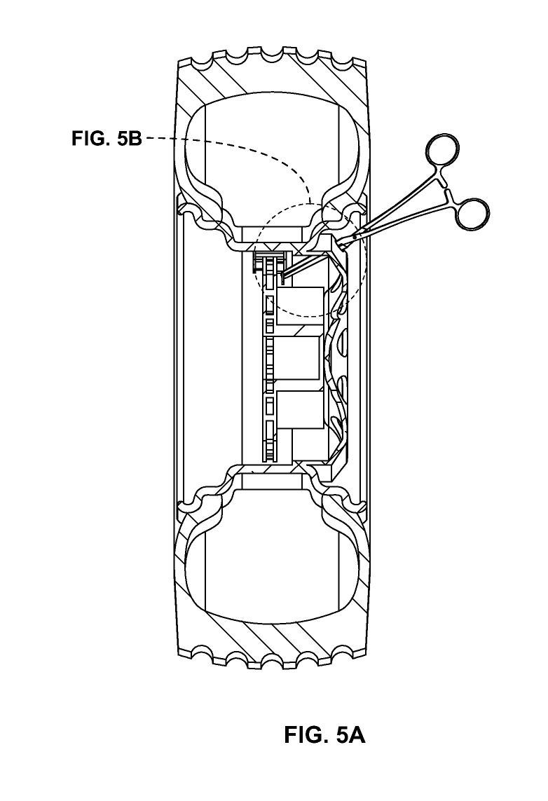

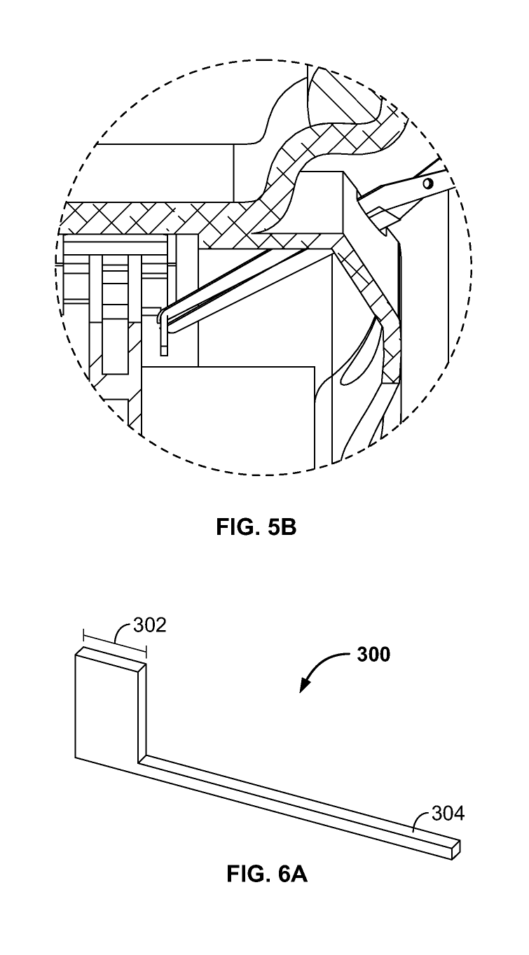

An embodiment shown in FIG. 2, illustrates the shaft 106 of the brake lining measurement Specialty Tool. Kit 100 inserted in an inspection window access point 116 of an enclosed Wheel Drum Brake Shoe assembly 102. In preferred embodiments, the second end 110 of the Heavy-Duty Brake Feeler Gauge is configured to measure the thickness of the Brake Shoe lining material thickness of a conventional automobile/light truck Wheel Drum Brake Shoe Brake system which provide an inspection access window on the inboard covered Wheel Brake Drum cover as shown in FIG. 2. In another utilization, the second end 110 of the Heavy-Duty Brake Feeler Gauge is configured to measure a Disc Brake pad as shown in FIGS. 5A and 5B.

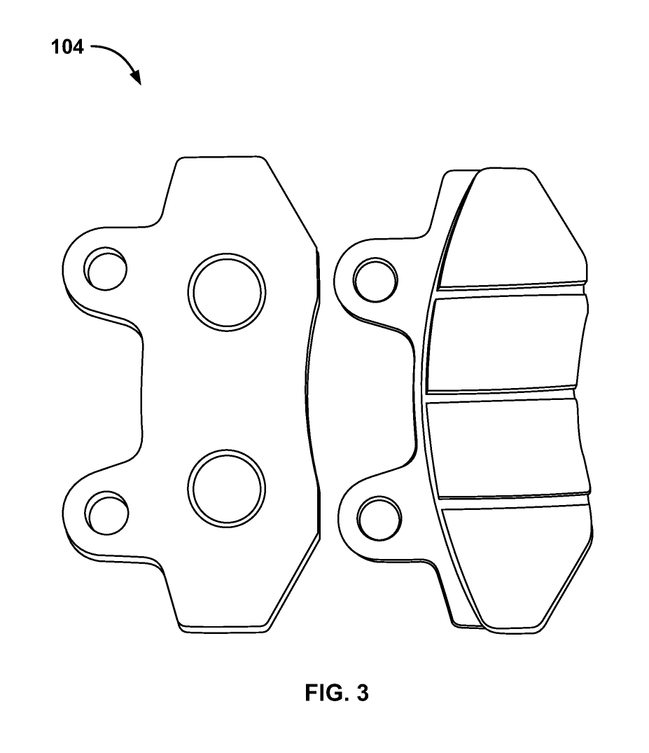

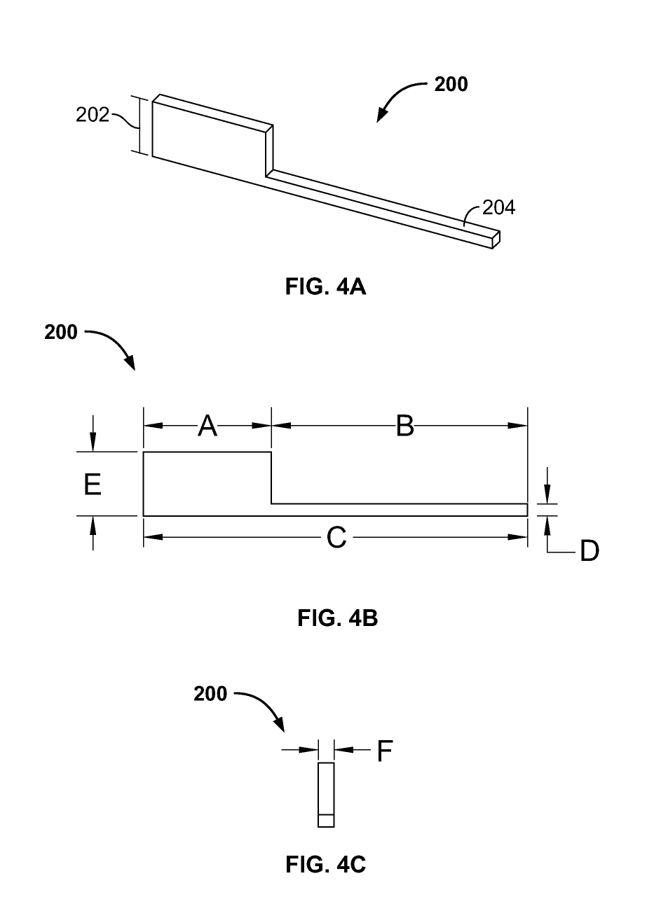

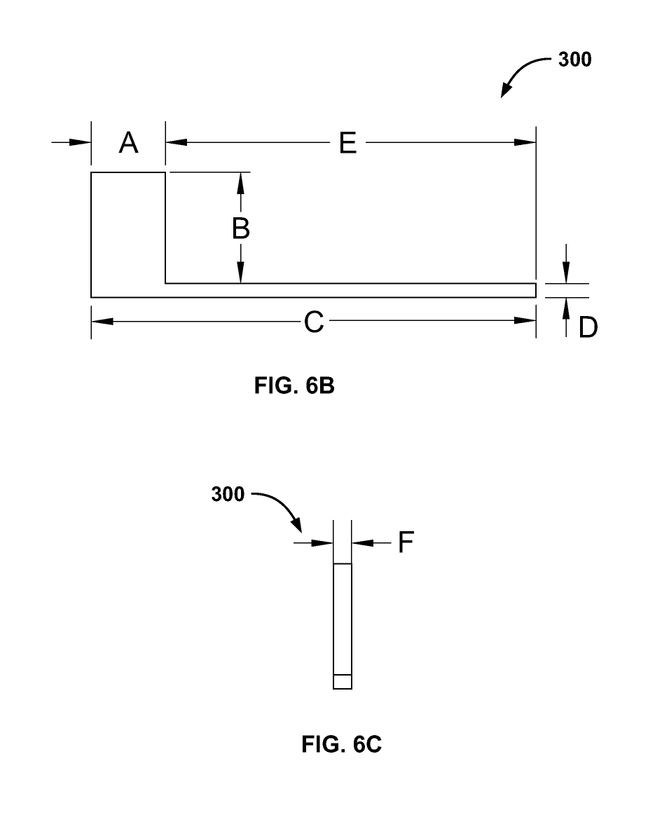

However, the present invention specialty tool Heavy-Duty Brake Feeler Gauge can also be used to measure the thickness of a Disc Brake pad 104 of a rotary Disc Brake pad in many cases without removing a wheel as shown in FIG. 5A and FIG. 5 B. Heavy-duty air brake systems are required by law in big rig trucks which utilize Wheel Drum Brakes wherein the Brake Shoes are exposed from the inboard side completely for the dual purpose of inspection and more importantly so that the Wheel Drum and Brake Shoe lining heat is ventilated allowing the heat of braking to dissipate. The Heavy-Duty Brake Feeler Gauge FIG. 4A and the Inspection/Access Window Disc Brake Gauge FIG. 6A from the Specialty Tool Kit 100 can be used to measure the material thickness of the Wheel Drum Brake Shoe lining in the Wheel Drum Brake assembly of a Heavy-Duty Truck Wheel Drum Brake system. Wheel Drum Brakes utilized on conventional automobile/light trucks with the access point 116 to insert the Heavy-Duty Brake Feeler Gauge, find that the Specialty Tool Kit 100 is applicable for use based on the present invention with the Heavy-Duty Brake Feeler Gauge FIG. 4A illustrated in FIG. 2. FIG. 3 Illustrates a general descriptive Disc Brake pad design for an automobile/light truck Disc Brake system, with the size and design being proportional to the respective size and weight of vehicle.

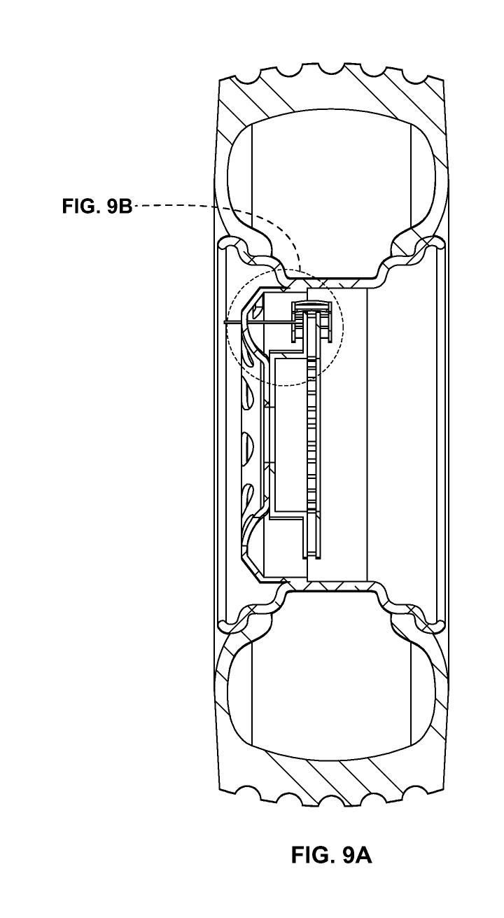

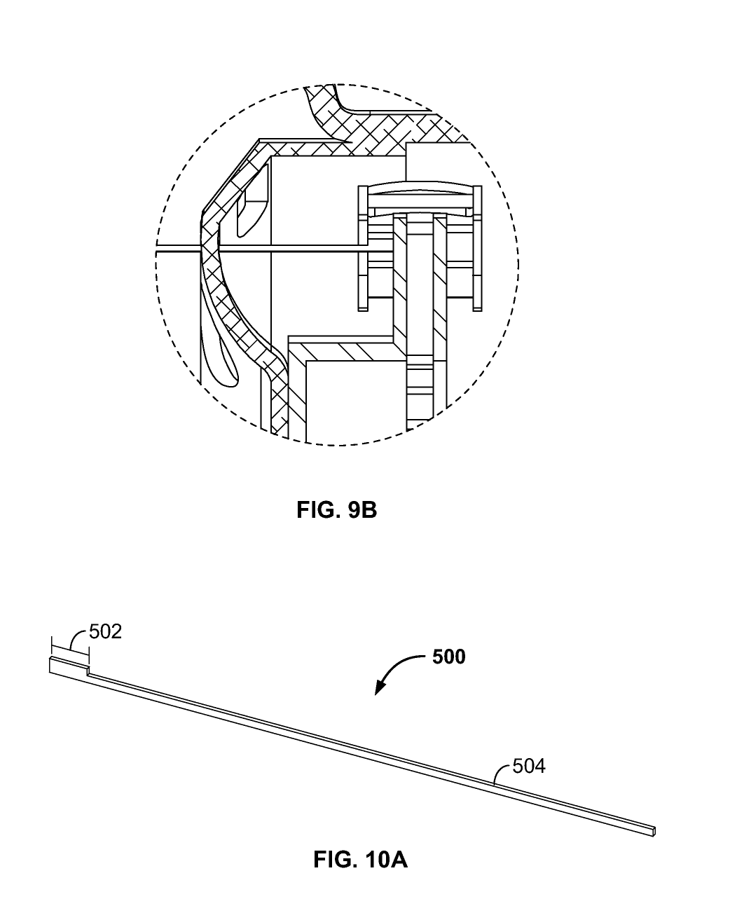

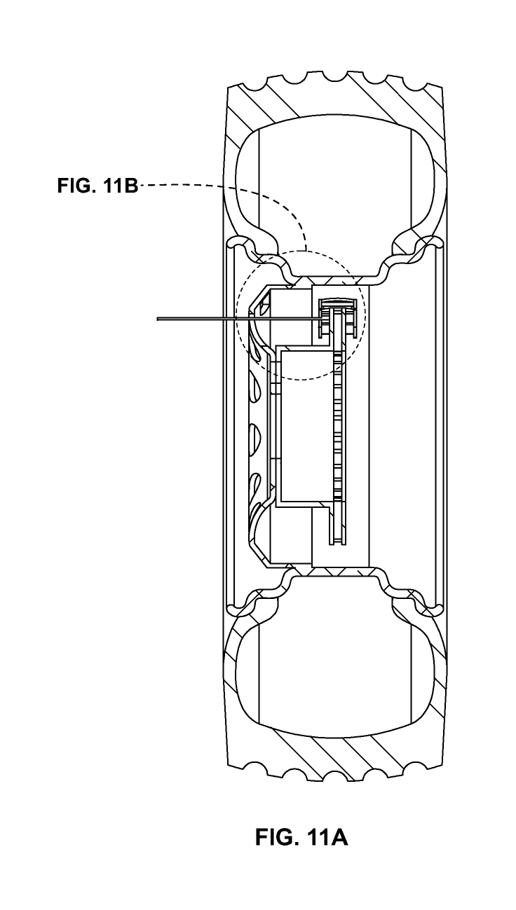

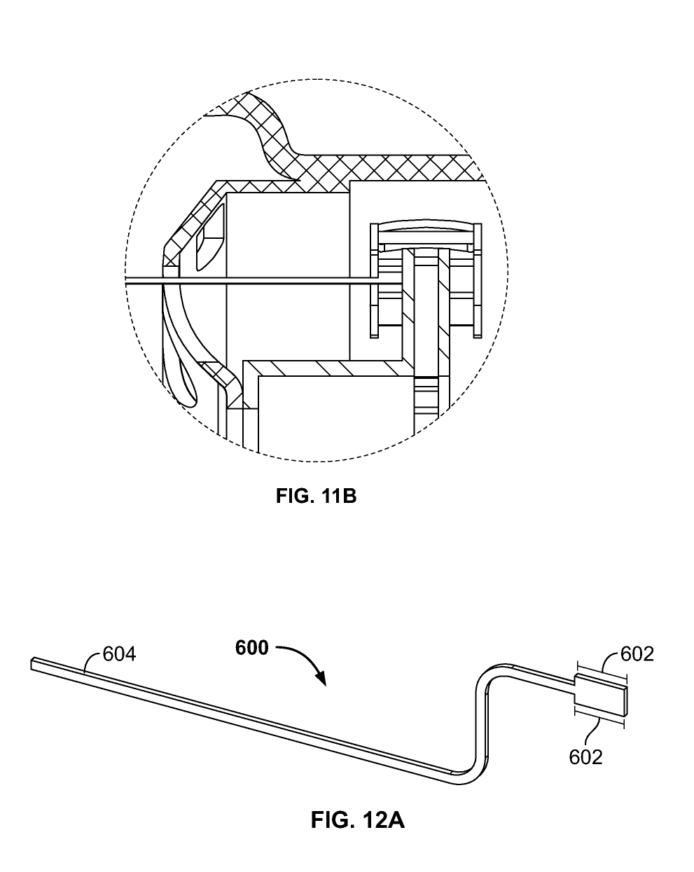

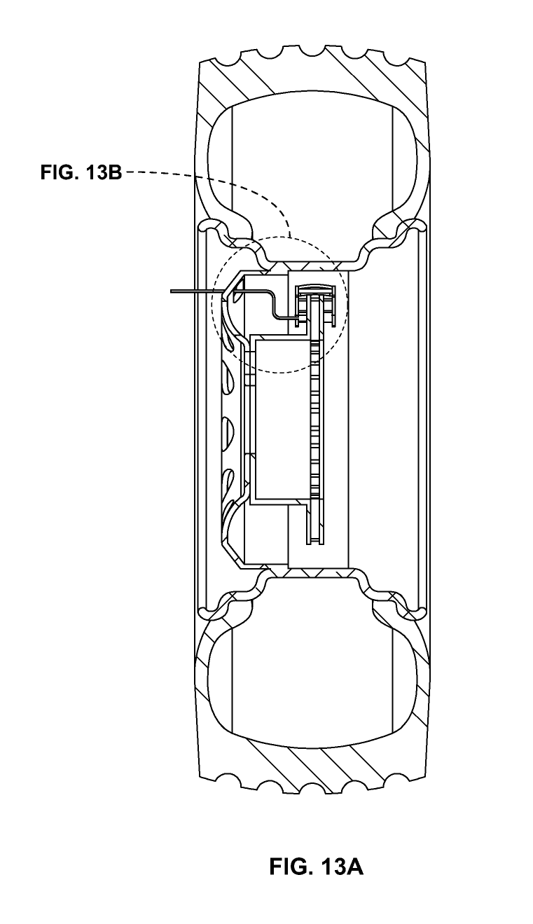

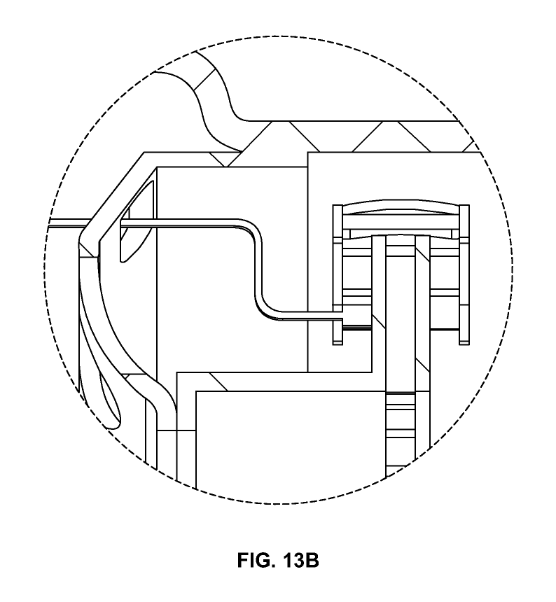

In the present invention, the shaft 106 is configured to be inserted through the wheel to measure the material thickness of a Disc Brake pad lining as shown in FIG. 9A, FIG. 9B, FIG. 11A, FIG. 11B, FIG. 13A, and FIG. 13B respectively. In preferred embodiments, each of the shafts 106 in the Specialty Tool Kit 100 are inserted through the wheel and respective brake system assembly to gain access to the brake lining for measurement. In the case of Disc Brake assemblies, to measure the brake pad 104 positioned between a rotor and backing plate of the Disc Brake pad. In the case of a rotary Disc Brake assembly, most inspections can he accessed through the street side of the wheel and from the inboard side of the wheel while the wheel is still attached to the axle. The invention of Specialty Tool Kit 100 gauge tools will overcome the normal challenges of physical obstruction inherent to automotive design, minimizing the amount of time spent inspecting Disc Brakes as the specialty tool substitutes for the requirement of having to remove and replace the wheel for Disc Brake inspection in most cases.

Shown in FIGS. 4A, 4B and 4C, is a Heavy-Duty Brake Feeler Gauge 200 for measuring the material thickness of the brake lining of Rotary Disc Brake pad lining and or Wheel Drum Brake Shoes of an automobile/light truck. As shown in FIG. 4A, the section 202 is configured to gauge the thickness of the brake lining using the handle section 204. Here, E is the base measurement of the gauge in increments of 1/32″ from 2/32″ to 16/32″ in addition to 9/16″ to 16/16″ in subsequent increments of 1/16″ whereas A denotes the length of the gauge section 202 and configured to be 0.375″ (⅜″) and the length of the handle section 204 is configured to be 2⅝″ denoted by B. The total length of the Heavy-Duty Brake Feeler Gauge 200 is configured to have 3″ denoted by C. The width of the handle section is configured to have 3/32″ denoted by D as shown in FIG. 4B. The material thickness of the Heavy-Duty Brake Feeler Gauge 200 is configured to be ⅛″ denoted by F in FIG. 4C. The Heavy-Duty Brake Feeler Gauge can be utilized on Wheel Drum Brake Shoes which provide an inspection access window on the inboard side of the covered Wheel Brake Drum illustrated in FIG. 2.

FIGS. 5A and 5B Illustrates a method of using the Heavy-Duty Brake Feeler Gauge 200 in measuring the thickness of the Disc Brake pad of an automobile/light truck. In cases where the Disc Brake pad is extremely difficult to access, the tool could be manipulated into place using pincers or forceps as shown in FIG. 5B.

FIGS. 6A, 6B and 6C Illustrates an Inspection/Access Window Disc Brake Gauge 300 in measuring the thickness of the Disc Brake pad of the rotary Disc Brake system of an automobile/light truck. As shown in FIG. 6A, the section 302 is configured to gauge the thickness of the Disc Brake pad using the handle section 304. As shown in FIG. 6B, A is the base measurement of the gauge in increments of 1/32″ from 2/32″ to 16/32″ in addition to 9/16″ to 16/16″ in subsequent increments of 1/16″ whereas B denotes the height of the gauge section 302 and configured to have ¾″. The width of the handle section is configured to have 3/32″ denoted by D. The total length of the inspection/Access Window Disc Brake Gauge 300 is configured to have 3″ denoted by C in FIG. 6B. The material thickness of this Inspection/Access Window Disc Brake Gauge 300 is configured to be ⅛″ denoted by F as shown in FIG. 6C.

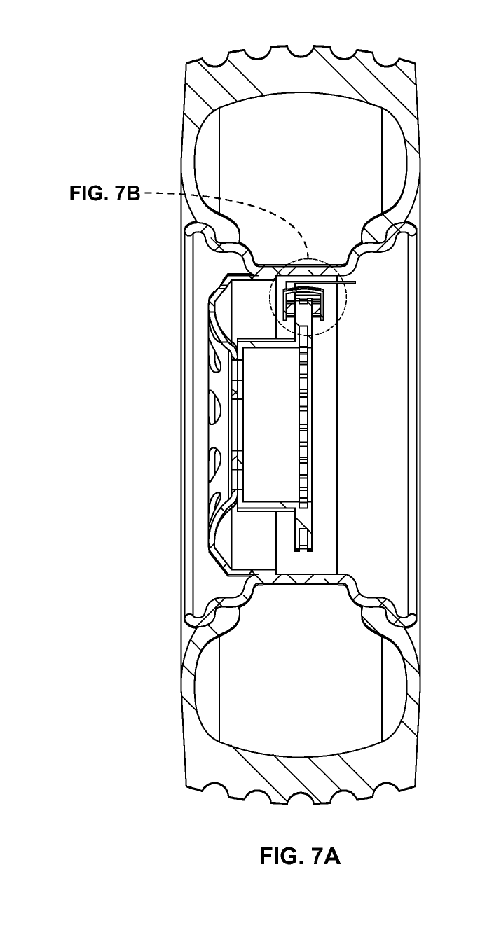

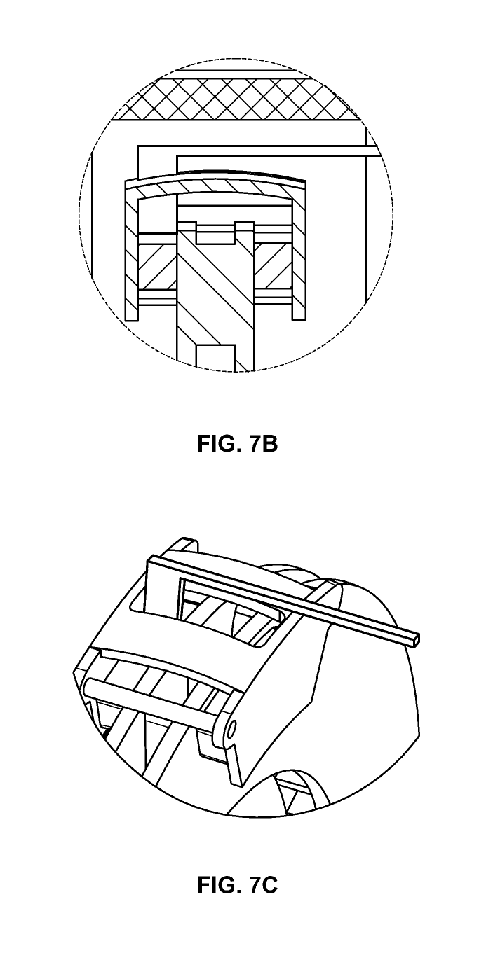

FIGS. 7A, 7B and 7C Illustrates the method of using the Inspection/Access Window Disc Brake Gauge 300 in measuring the thickness of the Disc Brake pad of the rotary Disc Brake system of an automobile/light truck. As shown in FIG. 7C, the Disc Brake assembly design incorporates an inspection window and allows physical access to the Disc Brake pad for inspection.

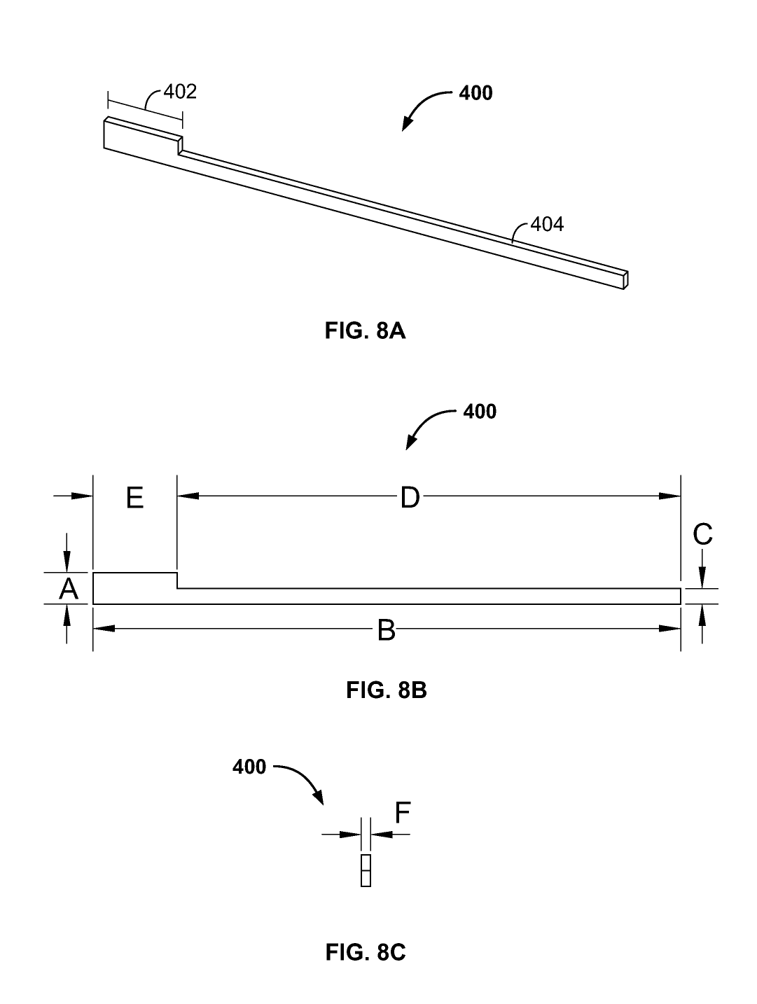

FIGS. 8A, 8B and 8C Illustrates the Standard Disc Brake Gauge 400 in measuring the thickness of the Disc Brake pad of the rotary Disc Brake system of an automobile/light truck. As shown in FIG. 8A, the section 402 is configured to gauge the thickness of the Disc Brake pad using the handle section 404. Here, E is the base measurement of the gauge in increments of 1/32″ from 2/32″ to 16/32″ whereas A denotes the height of the gauge section 402 and configured to have 3/16″. The thickness of the handle section is configured to have 3/32″ denoted by C as shown in FIG. 8B. The total length of standard Disc Brake pad gauge 400 is configured to have 3½″ denoted by B. Here, D=is equal to B−E. The material thickness of this standard Disc Brake gauge is configured to be 0.056″ denoted by F in FIG. 8C.

FIGS. 9A and 9B Illustrates the method of using the Standard Disc Brake Gauge 400 in measuring the thickness of the Disc Brake pad of the rotary Disc Brake system of an automobile/light truck. As shown in FIG. 9B, the Disc Brake pad is in line of sight through the wheel with access for the Standard Disc Brake Gauge to measure the material thickness of the Disc Brake pad.

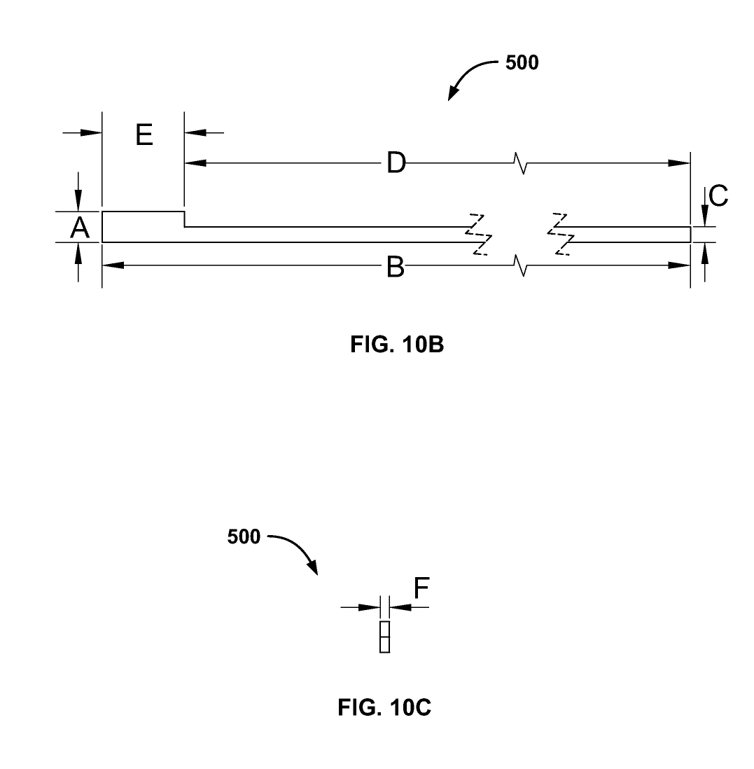

FIGS. 10A, 10B and 10C Illustrates an Extended Disc Brake Gauge 500. As shown in FIG. 10A, the section 502 is configured to gauge the thickness of the Disc Brake pad using the handle section 504. As shown in FIG. 10B, E is the base measurement of the gauge in increments of 1/32″ from 2/32″ to 16/32″ whereas A denotes the height of the gauge section 502 and configured to have 3/16″. The width of the handle section is configured to have 3/32″ denoted by C as shown in FIG. 10B. The total length of the Extended Disc Brake Gauge 500 is configured to have 8″ denoted by B. In FIG. 10B, the material thickness of the Extended Disc Brake Gauge 500 is configured to be 0.056″ denoted by F as shown in FIG. 10C.

FIGS. 11A and 11B Illustrates the method of using the Extended Disc Brake Gauge 500 in measuring the material thickness of the Disc Brake pad of the rotary Disc Brake system of an automobile/light truck. As shown in FIGS. 11A and 11B, the Extended Disc Brake Gauge is extended through the length of the wheel well which has a deep cavity and in this example, can measure the material thickness of the Disc Brake pad by using the Extended Disc Brake Gauge. The Extended Disc Brake Gauge 500 is utilized on the inboard side of a given wheel in which the Disc Brake assembly is blocked by mechanical structure whereby the extension of the gauge can penetrate further through obstructions.

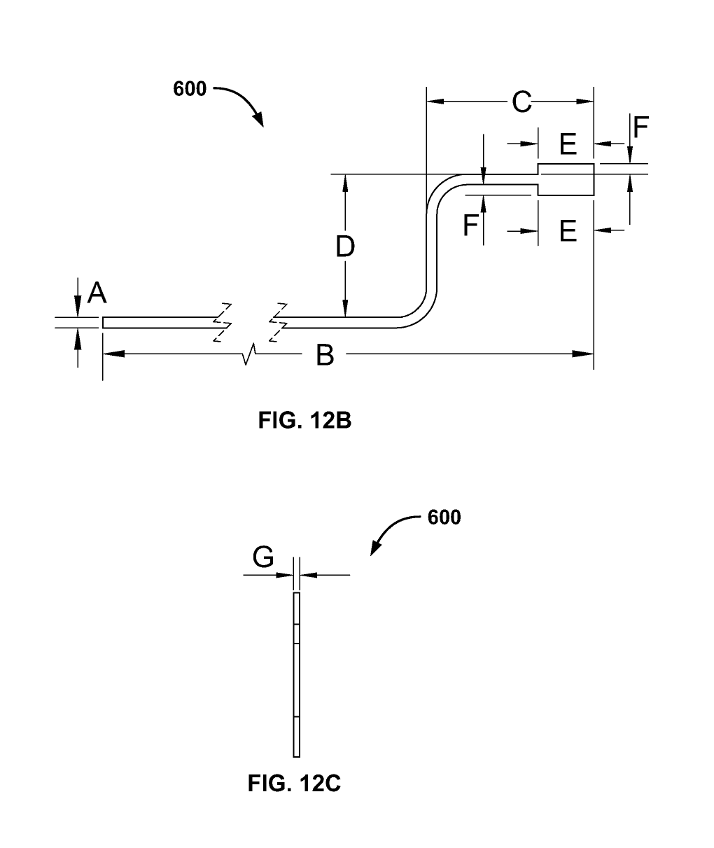

FIGS. 12A, 12B and 12C Illustrates an Ambidextrous “S” Hammer Head Disc Brake Gauge 600 in measuring the thickness of the brake pad of the rotary Disc Brake system of an automobile/light truck. As shown in FIG. 12A, the section 602 is configured to gauge the thickness of the brake using the handle section 604. As noted in FIG. 12B, E is the base measurement of the gauge in increments of 1/32″ from 2/32″ to 16/32″ whereas A denotes the height of the handle section 604 and configured to have 3/32″ height. The total length of the Ambidextrous “S” Hammer Head Disc Brake Gauge 600 is configured to have 6″ denoted by B. The handle section 604 and gauge section 602 is configured with a curved section having inner radius R.27 and outer radius R.36 respectively. The length of the curved support section containing the gauge section 604 is configured to have 1½″ and denoted by C. The dimension of the vertical support section between the handle section 604 and gauge section 602 is configured to have 1⅜″ and denoted by D. The material thickness of the Ambidextrous “S” Hammer Head Disc Brake Gauge 600 is configured to be 0.056″ denoted by G in FIG. 12C.

FIGS. 13A and 13B Illustrates the method of using the Ambidextrous “S” Hammer Head Disc Brake Gauge 600 in measuring the thickness of the Disc Brake pad of the rotary Disc Brake system of an automobile/light truck in which case there is no direct line of sight access to the point of measurement. As shown in FIGS. 13A and 13B in which case, the Disc Brake pad is offset from line of sight, the Ambidextrous “S” Hammer Head Disc Brake Gauge 600 accommodates the physical obstruction to allow measurement.

In a different embodiment, in the case of measuring a Wheel Drum Brake Shoe lining 116 material thickness, whether the Wheel Drum Brakes are on conventional automobile/light trucks or a Heavy-Duty Truck Air Brake Wheel Drum Brake system, a given embodiment of the Specialty Tool Kit 100 is inserted between the Wheel Brake Drum rim and the backing plate of the respective Wheel Drum Brake Shoe backing plate to gauge and measure the material thickness of the Wheel Drum Brake Shoe lining material thickness.

Wheel Drum Brake Shoes of a conventional automobile/light truck are typically inspected and measured with the wheels of a given vehicle removed from the vehicles axle. In cases where the Original Equipment Manufacturer (OEM) designs an inspection access window onto the back of the Wheel Drum Brake assembly enclosed back cover an embodiment of the Specialty Tool Kit 100 can be applied as illustrated in FIG. 2. Brake Drum Shoe linings of a Heavy-Duty Air Brake Wheel Drum Brake system are open and exposed from the inboard side and can be measured while the wheel is on the axle from the inboard side with no obstruction.

In preferred embodiments, the shaft 106 is manufactured from a laser machining process to provide accurate measurement of the thickness of the brake lining material thickness. Additionally, the shafts 106 are laser marked to indicate the measured index of each individual gauge in increments of 32nds of an inch and 16^{th} inch increments in varying embodiments, to measure the thickness of brake lining material thickness. In addition, the different embodiments of the brake lining measurement Specialty Tool Kit 100 shafts 106 are configured to have color coding to define the size variation of different shafts 106 in the Specialty Tool Kit 100. For instance, a yellow color indication on the shaft 106 denotes a 9/32″ inch shaft, red on the shaft denotes a 7/32″ inch shaft, etc.

In an exemplary embodiment shown in FIG. 102, a method of utilizing the brake lining measurement Specialty Tool Kit 100 to measure the thickness of the Brake Shoe lining 116 of the Wheel Drum Brake assembly 102 is shown. As illustrated in FIG. 102, the Brake Shoe lining can be measured without removing the wheel by guiding the gauge section 114 of the desired shaft 106 adaptively into the access point 116 utilizing the brake lining measurement specialty Heavy-Duty Brake Feeler Gauge 200 through the Wheel Drum Brake enclosure access window to measure the Drum Brake Shoe lining in cases where the Wheel Drum Brake Shoe enclosure inspection window is provided by the O.E.M. as shown in FIG. 102.

The gauge section 110 is made to be placed between the Wheel Drum 116 and backing plate of the Brake Shoe lining of the Wheel Drum Brake assembly 102 and the user can measure the thickness of the Brake Shoe lining material within 1/32 increments of an inch as shown in FIG. 2. As brake lining measurement Specialty tool kit 100 is comprised of five different shafts 106 having predefined configurations of gauge sections it may be adaptively used to accomplish the measuring task quickly and accurately without the automotive technician having to remove and replace each wheel to measure brake lining material thickness. In the case of rotary Disc Brakes, the technician inserts the shaft 106 in between the Rotary Disc Brake assembly and rotates the shaft 106 to fit the gauge section 114 of the second end 110 between the backing plate of the Disc Brake pad and the Disc Brake rotor, the measurement of the thickness can be accomplished within 1/32 increments of an inch.

The brake lining measurement Specialty Tool Kit 100, per the present invention provides a Specialty Tool Kit 100 with a set of different shafts 106 having a plurality of configurations to accommodate the form and fit the designs of many various combined brake and wheel assemblies despite the physical obstructions of the combination of the wheel being simultaneously attached to the axle and blocking the brake assembly. Manufactured from a malleable metal alloy material, brake lining measurement Specialty Tool Kit 100 has adequate durability and flexibility uses with high quality assurance.

The brake lining measurement Specialty Tool Kit 100 comprises different shafts 106 selected from a Standard Disc Brake Gauge, an Extended Disc Brake Gauge, the Ambidextrous “S” Hammer Head Disc Brake Gauge, the Inspection/Access Window Disc Brake Gauge and the Heavy-Duty Brake Feeler Gauge. All of which allows this invention to be useful in both versatile applications and complex physical challenges during the measurement process. The user can measure both the inboard and outboard Disc Brake pad 104 without removing the wheel of the vehicle in most cases. The brake lining measurement Specialty Tool Kit 100 is configured to measure Disc Brake pad 104 material thickness in a plurality of vehicles including sedan and light trucks. Additional embodiments of the brake lining measurement specialty tool kit, allows for the present invention to be utilized with Wheel Drum Brake systems on conventional automobile/light trucks given that the Drum Brake OEM system has provided inspection access windows on the back enclosure of the Wheel Brake Drum, Heavy-Duty Air Brake Wheel Drum Brake Shoe systems without removing the wheels, and on exposed railway train Disc Brakes as well.

In most cases an Automotive Technician can measure the material thickness of both Disc Brake pads 104 on the Disc Brake assembly of each individual wheel. The present invention saves time, reduces fatigue, reduces cost, as well as reducing electrical energy consumed by air compressor. The indices on the brake lining measurement Specialty Tool Kit 100 allows for easier identification of the shaft intended for this specific purpose.

Although the present invention has been described herein in the context of a specific implementation in an environment for a particular purpose, those with ordinary skill in the art and science will recognize that its usefulness is not limited thereto and that the present invention may be beneficially implemented in any number of environments for any number of purposes. For example, train rail car Disc Brakes being for such use. Accordingly, the claims set forth below should be construed in view of the full breadth and spirit of the present invention as described herein.

I claim:

1. A tool kit for measuring the material thickness of: automobile/light truck Disc Brake pads; automobile/light truck Wheel Drum Brake Shoe lining; Heavy-Duty Air. Brake Wheel Drum. Brake Shoe lining; exposed train rail Disc Brakes.
The tool kit comprises:
a shaft comprising a first end and a second end to define a predetermined length of rectangular cross-section, wherein the first end is a handle configured to have a gripping section and the second end is a gauge section configured to measure the material thickness of the brake lining via a recessed area of predefined height without removing a wheel assembly of the automobile/light truck in most cases.

2. The tool kit of claim 1, further comprises at least five shafts with gauge sections of predefined dimensions to measure the thickness of the brake lining of various automobile and truck wheel brake system configurations.

3. The tool kit of claim 1, wherein the shaft is made from a malleable metal alloy material.

4. The tool kit of claim 1, wherein the shaft is manufactured from a laser machining process.

5. The tool kit of claim 1, wherein the configuration of the shaft is selected from at least one of a Standard Disc Brake Gauge, an Extended Disc Brake Gauge, the Ambidextrous “S” Hammer Head Disc Brake Gauge, the Inspection/Access Window Disc Brake Gauge and a Heavy-Duty Brake Feeler Gauge.

6. The tool kit of claim I, wherein the shaft is configured to be inserted through an access point of the brake assembly to measure the thickness of the brake pad material thickness.

7. The tool kit of claim 1, wherein the shaft is configured to measure the thickness of the brake lining ranging from 3/32 inches to 16/32 in increments of 32nd of an inch in addition from ½″ to 1″ in increments of 1/16″.

8. The tool kit of claim 1, wherein the shafts are laser marked and color coded to indicate the measuring scale to measure the thickness of the brake lining.

9. The tool kit of claim 1, wherein the shafts are configured to measure the thickness of the brake lining installed in at least one of an automobile/light truck rotary Disc Brake assembly, conventional automobile/light truck Wheel Drum Brake assembly, a Heavy-Duty Truck Air Brake Wheel Drum Brake assembly or exposed train rail Disc Brake pad lining.
